(19) United States
(12) Patent Application Publication
(10) Pub. No.: US 2009/0224060 A1
(43) Pub. Date: Sep. 10, 2009

(54) SECURE CREDIT CARD

(76) Inventor: MEHDI HATAMIAN, Coto De Caza, CA (US)

Correspondence Address: STETINA BRUNDA GARRED & BRUCKER, 75 ENTERPRISE, SUITE 250, ALISO VIEJO, CA, 92656, US

(21) Appl. No.: 12/401,008

(22) Filed: Mar. 10, 2009

Related U.S. Application Data
(60) Provisional application No. 61/068,788, filed on Mar. 10, 2008.

(51) Int. Cl. G06K 19/067

(52) U.S. Cl. 235/492

(57) ABSTRACT

A secure electronic credit card to provide the functionality of a conventional credit card with additional security protocols to thwart credit card fraud and theft. The electronic credit card may be employed to utilize multiple conventional credit cards in one card. In addition, the card may be password protected and allows for real time remote programming of a new credit card number by the credit card issuer. The electronic credit card is communicable with the credit card issuer at the time of a transaction, such that the credit card issuer may verify that the transaction is valid.

### CROSS-REFERENCE TO RELATED APPLICATIONS

This application claims the benefit of U.S. Provisional Patent Application Ser. No. 61/068,788, filed on Mar. 10, 2008, the teachings of which are expressly incorporated by reference.

### STATEMENT RE: FEDERALLY SPONSORED RESEARCH/DEVELOPMENT

Not Applicable

### BACKGROUND

1. Field of the Invention

The present invention relates to credit cards and more specifically to electronic credit cards that enable security protocols to make the credit card and credit card transactions more secure and provide protection against theft and unauthorized use.

2. Description of the Related Art

The widespread availability and convenient use of credit cards for general financial transactions have proliferated the number of credit cards throughout the world. In this regard, financial institutions as well as commercial stores routinely administer credit cards to facilitate transactions.

Along with the benefits and ease of use, these inexpensive and readily available cards are highly susceptible to unauthorized use and theft. In today's global marketplace, consumers routinely use credit cards when conducting financial transactions over the Internet and telephone. In doing so, consumers become susceptible to credit card theft and fraud. Credit card companies have attempted to thwart credit card theft. Attempts to detect forged or altered credit cards have involved placing magnetic strips, codes, or similar means of deterring fraud. However, these schemes have not prevented thieves from either deciphering the codes or, alternatively, forging a new credit card. The losses associated with the unauthorized use of these cards can have dramatic effects on the card user and the financial institutions providing these services.

Security primarily depends on maintaining personal possession of the cards and minimizing access to the account numbers as much as possible. However, credit card theft is further complicated by the generation and falsification of these cards with illegally obtained personal identification numbers. The safest way to protect a credit card number is for the issuing company to administer a new credit card number on a regular basis. Traditionally, credit card companies would mail consumers a new credit card with a new number if their card was lost or if theft had occurred. However, the caveat of exercising this business process is that the user is unable to employ the credit card until the new one had arrived. Such a procedure could take weeks to process a request for a new credit card number and the subsequent issuance of a new credit card.

Therefore, there is currently a need in the art for an electronic credit card that is capable of employing adaptive security protocols such that a new credit card number is issued in real time and the that the credit card is password protected.

### BRIEF SUMMARY OF THE INVENTION

In accordance with the present invention, there is provided multiple embodiments of an electronic credit card. In a basic embodiment of the present invention, the electronic credit card may include a package having vertical and horizontal dimensions of a standard credit card and including first and second opposing faces. In addition, the electronic credit card is comprised of a microprocessor having a memory to store data embedded within the electronic card, a power source, at least one input device for entering data into the computer processor, a display, a means for communicating with a standard point of sales reader and a communications device that is communicable with the credit card issuer and a computer interface.

In one embodiment of the present invention, the electronic credit card communicates with a standard point of sales reader by utilizing magnetic coils that are aligned in accordance to standard point of sales reader positions. Electric current is passed through the magnetic coils generating a magnetic field that may be sensed and read by the point of sales reader. A stripe may be disposed over the magnetic coils. The stripe may be a magnetic stripe. In another embodiment of the present invention a microchip is embedded within the electronic credit card. The microchip is positioned in accordance with standard positions accepted by a point of sales reader and is capable of generating a magnetic field that is read by a point of sales reader.

In another embodiment of the present invention the microprocessor is configured to store multiple credit card numbers and employs a particular credit card number in response to user selection. In another embodiment of the present invention, the microprocessor may contain a random number generator that generates a new credit card number at a periodic interval of time. The electronic credit card may be synchronized with the credit card issuer such that the credit card issuer updates its records of the credit card as the number changes. The microprocessor may be configured to actively store and maintain a password that monitors the activation of a credit card number.

Further in accordance with the present invention, there is provided a method to supplement an electronic credit card with a new credit card number at a prescribed periodic interval of time and validate the credit card number prior to completing a transaction. The method initializes by synchronizing a random number generator, stored inside of a microprocessor embedded in an electronic credit card, with a random number generator stored at an external data source, so that the periodic intervals of time of the random number generators are the same. The method continues by generating a new credit card number via the random number generator in an electronic credit card at a prescribed periodic interval of time and a new number at the external data source. The method continues by transmitting the credit card number from an electronic credit card to an external data source, such that the credit card number is verified at the time of a transaction.

The present invention is best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1A depicts a first face of an exemplary electronic credit card which has a microprocessor embedded within it, an internal power source, a display screen, and input buttons;

FIG. 1B depicts a second face of an exemplary electronic credit card which has a programmable magnetic strip and magnetic coils;

FIG. 2 depicts a flow chart laying out the process by which an electronic credit card is synchronized with a credit card issuer and receives a new credit card number.

### DETAILED DESCRIPTION

The detailed description set forth below is intended as a description of the presently preferred embodiment of the invention and is not intended to represent the only form in which the present invention may be constructed or utilized. The description sets forth the functions and sequences of steps for constructing and operating the invention. It is to be understood, however, that the same or equivalent functions and sequences may be accomplished by different embodiments and that they also are intended to be encompassed within the scope of the invention.

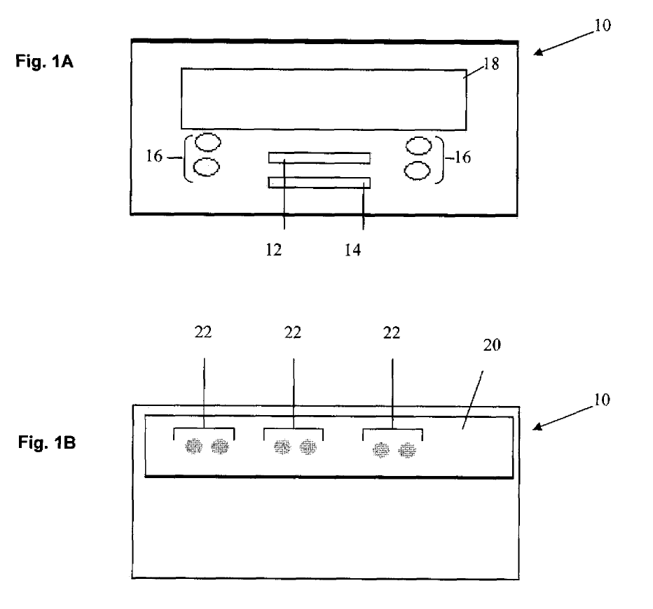

Referring now to the drawings wherein the showings are for purposes of illustrating various embodiments of the present invention only, and not for purposes of limiting the same, FIGS. 1A and 1B depict an electronic credit card 10 in accordance with the present invention. An electronic credit card 10 has first and second opposing faces and may be programmed with a credit card number and can allow for readily changeable passwords, access codes and the like to thus render the card to be either selectively utilized or otherwise have a readily adjustable spending limit. In addition, the electronic credit card 10 may be configured such that it is packaged relative to the same horizontal and vertical dimensions of conventional credit cards. The electronic credit card 10 is not a smart card that traditionally employs RFIDs or the like. However, it is contemplated that the electronic credit card 10 may be compatible with traditional smart cards.

An electronic credit card 10 comprises a microprocessor 12 that is embedded within the package of the credit card, a power source 14 that is embedded within the credit card, at least one input device 16 for entering data into the microprocessor, a display screen 18, a means for communicating with a point of sales reader, and a communications device that is communicable with an external data source and a computer interface.

The microprocessor 12 has memory to store data and is operative to run a variety of software programs. In this regard, the microprocessor stores pertinent data relative to the credit card, such as credit card numbers, authentication data, passwords, and the like. The microprocessor 12 may come preprogrammed by an external data source, such as the credit card issuer. Alternatively, the microprocessor 12 may be programmed in real time remotely by the credit card issuer utilizing wireless technologies, such as Bluetooth or the like.

The input device 16 may be keys or buttons that are capable of being manipulated by the user to input data into the electronic credit card 10. The present invention utilizes four input keys to enter data into the credit card. In addition, the input device 16 may be utilized to navigate and employ various features preprogrammed in the microprocessor 12. However, it is also contemplated that the credit card may utilize wireless technologies to input data. The display 18 will display pertinent data to the user such as spending limits, passwords, and the like. The display 18 may be an LCD screen or the like that is positioned on the face of the package of the electronic credit card 10.

The electronic credit card 10 has the capability to work in a similar fashion as conventional credit cards. In this regard, the electronic credit card 10 is communicable with standard point of sales readers, ATM machines and the like. In order to enable the features of standard credit cards, the electronic credit card 10 may employ the features of a programmable strip 20. The strip 20 may be a magnetic strip. In one embodiment of the present invention, compatibility with the existing point of sales reader devices is achieved through a programmable magnetic strip 20 which, in size and external appearance, is identical to the magnetic strips on conventional credit cards. Underneath the strip 20 there are a number of magnetic coils 22, each centered at the exact bit positions corresponding to the information bit positions on the conventional cards. The passing of an electronic current through the magnetic coils 20 generates magnetic fields that can be sensed and read by the card reader devices currently in use in the same way the magnetic field on the stripe of conventional cards are sensed and read. The programmable strip 20 feature of the card advantageously allows users and retailers to adapt to the new electronic credit card 10 with ease as it follows conventional methods employed by users.

In an alternative embodiment of the present invention, the electronic credit card 10 employs a microchip (not shown) that is embedded within the package to actively maintain the requisite magnetic functions such that the electronic credit card may be employed with existing card readers. In addition, the microchip is positioned such that it is recognized and communicable with conventional card readers. Oftentimes magnetic stripes on conventional credit cards wear out with time, lose their magnetic field strength, and can also be demagnetized in the presence of certain electronic instruments. The present electronic credit card advantageously maintains its magnetic strength thereby overcoming the shortfalls of conventional credit cards.

The electronic credit card 10 may employ a variety of security protocols to minimize the inherent risks associated with conventional credit cards. In one embodiment of the present invention, the security feature of the electronic credit card 10 is offered through a simple algorithm that allows the electronic credit card 10 to dynamically change its credit card number at certain periodic intervals of time. As such, the microprocessor 12 runs a random number generator program that may generate a new credit card number for the electronic credit card 10. When the electronic credit card 10 is originally issued, this random number generator is synchronized with a similar random number generator with the credit card issuer. The credit card issuer may actively keep track of the card and subsequently grant access for use at specific transactions. The two random number generators, one in the electronic credit card 10 and the other with the credit card issuer, produce a new credit card number at certain periodic intervals of time.

The periodic interval may be programmed and modified by the issuer of the credit card as one of a number of overall system parameters selected by the authorized issuers of the credit card. When the card is used in a transaction environment and a request for verification is submitted to the credit card issuer, the two random numbers are compared and matched before access is granted. Each number remains valid for only a short period of time equal to the periodic interval of time selected as a system parameter by the issuer. As a result, even if the number is stolen during a transaction, it will not be useful. As an example, if the periodic interval is set to 4 minutes, the process will be equivalent to canceling a conventional credit card every 4 minutes and issuing a new one.

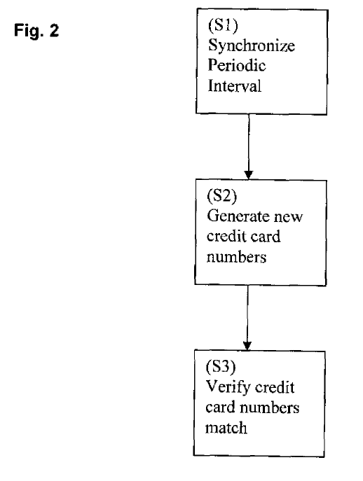

FIG. 2 depicts the flow of an exemplary method in which an electronic credit card 10 is supplemented with a new credit card number at a prescribed periodic interval of time and validates the credit card number with the credit card issuer prior to completing a transaction. The method (S1) begins by synchronizing a random number generator, stored inside of a microprocessor 12 embedded in an electronic credit card 10, with a random number generator stored with a credit card issuer. The synchronization of the random number generators sets the periodic interval of time in the electronic credit card and with the credit card issuer to be the same. The method continues (S2) by generating a new credit card number via the random number generator in an electronic credit card 10 at the prescribed periodic interval of time and a new number at the credit card issuer. As a result, when the electronic credit card 10 generates a new credit card number, the credit card issuer updates its record simultaneously.

The method continues (S3) by transmitting the credit card number from an electronic credit card 10 to the credit card issuer, such that the credit card number is verified at the time of a transaction. In this regard, the credit card issuer may decline the transaction if the numbers do not match. This process provides an added level of secure transaction that safeguards against credit card theft.

In an alternative embodiment of the present invention, the credit card number may be changed or updated based on transactions. In this regard, a credit card number will change after it is used a set number of times with its current number. As such, rather than modifying the two random number generators periodically; they are modified according to usage. Therefore, when the electronic credit card 10 is used a preset number of times, the credit card number changes, both on the electronic credit card 10 and at the data center, after the transaction is authorized. This feature may be advantageous for certain on-line transactions where the authorization may take longer than the periodic interval method.

In an alternative embodiment of the present invention, the electronic credit card 10 requires the user to enter a password to activate the electronic credit card 10 for use. This feature advantageously protects the card against physical theft. Therefore, if the electronic credit card is stolen, the subsequent user's lack of knowledge of the password renders the card useless. The user may manipulate the input device 16 to enter the password. In addition, it contemplated that the issuer of the credit card may remotely reset the password if so required.

It is contemplated that the programmable magnetic strip 20 of the electronic credit card 10 may be programmed in real time. In this regard, the electronic credit card 10 may also be programmed to take on different identities; such as Visa, Master Card, American Express, commercial vendor cards, gas station cards, debit cards, ATM cards, and the like. It is contemplated that a user may navigate through the selection of credit cards and select the desired card by viewing the card on the display screen 18 and manipulating the input buttons 16. The electronic credit card 10 may be configured such that the more popular cards may be expeditiously selected via a special key on the face of the card. The convenient special key facilitates the user to select the more popular cards quickly.

In another embodiment of the present invention, each electronic credit card 10 has a static credit card number similar to the fixed credit card number of conventional credit cards. This fixed number may allow the card owner to use it as a conventional credit card number. The electronic credit card 10 is protected by password, thereby rendering the card unusable if stolen. Additionally, the electronic credit card 10 may store numerous fixed credit card numbers. In this regard, the electronic credit card 10 may store a fixed number for every conventional credit card it electronically stores.

The internal power source 14 advantageously employs a power management implementation. As such, the power source 14 may be configured to only keep the essential components of the electronic credit card 10 active. The remaining components are turned off until the electronic credit card 10 is turned on by the user. The electronic credit card 10 remains on until it is turned off or timed out. It is contemplated that the power source may be charged when the power supply is running low.

What is claimed is:

1. An electronic credit card comprising:
a package having a vertical dimension of a standard credit card and a horizontal dimension of a standard credit card and including a first face and a second opposing face;
a microprocessor having a memory to store data and being operative to run a software program which is stored in the memory;
a power source embedded within the package for providing power to the electronic credit card;
at least one input device for entering a quantity of data into the microprocessor;
a display screen;
a means for communicating with a point of sales reader; and
a communications device that is communicable with an external data source and a computer interface;
wherein the microprocessor is configured to actively store and maintain at least one credit card number.

2. The electronic credit card of claim 1 further comprising:
at least one magnetic coil on the second face positioned in accordance to at least one standard position accepted by the point of sales reader; and
a stripe disposed over the magnetic coil.

3. The electronic credit card of claim 2, wherein the stripe is a magnetic stripe.

4. The electronic credit card of claim 2 wherein electric current is passed through the magnetic coils to generate a magnetic field that is read by the point of sales reader.

5. The electronic credit card of claim 1 further comprising:
a microchip embedded within the electronic credit card and positioned in accordance with at least one standard position accepted by the point of sales reader.

6. The electronic credit card of claim 5, wherein the microchip is configured to generate a magnetic field that is read by a point of sales reader.

7. The electronic credit card of claim 1, wherein the microprocessor is configured to deploy the credit card number that is selected by a user via the input device.

8. The electronic credit card of claim 1, wherein the microprocessor actively stores a random number generator which generates a credit card number at a periodic interval of time.

9. The electronic credit card of claim 8, wherein the periodic interval of time of the microprocessor is synchronized with an external data source so that the credit card number is generated in tandem with the external data source.

10. The electronic credit card of claim 8, wherein the periodic interval of time of the microprocessor is set by an external source.

11. The electronic credit card of claim 1, wherein the credit card number is programmed in real time by an external data source.

12. The electronic credit card of claim 8, wherein the random number generator of the microprocessor generates a new credit card number after the electronic credit card is used in at least one transaction.

13. The electronic credit card of claim 1, wherein the input device is a keyboard disposed on the first face of the package.

14. The electronic credit card of claim 1, wherein the communications device transmits data between the electronic credit card and the external data source through wireless technology.

15. The electronic credit card of claim 1 further comprising a power button disposed on the package which powers on and off the electronic credit card.

16. The electronic credit card of claim 1, wherein the microprocessor stores a password that actively secures the at least one credit card number and the credit card number is deployed when a user enters the password via the input device.

17. The electronic credit card of claim 1, wherein the microprocessor is capable of receiving a new password from the external data source.

18. The electronic credit card of claim 1, wherein the microprocessor stores a password for each credit card number, such that a credit card number is activated when the corresponding password is entered.

19. The electronic credit card of claim 1, wherein the electronic credit card is a smart card.

20. The electronic credit card of claim 1, wherein the power source powers off at a preset time.

21. A method is provided to supplement an electronic credit card with a new credit card number at a prescribed periodic interval of time and to validate the new credit card number prior to completing a transaction, comprising the steps of:
synchronizing a first random number generator, stored inside of a microprocessor embedded in an electronic credit card, with a second random number generator stored at an external data source, so that the periodic interval of time of the first and second random number generators are the same;
generating a new credit card number via the random number generator in an electronic credit card at a prescribed periodic interval of time and a new number at the external data source; and
transmitting the credit card number from an electronic credit card to an external data source, such that the credit card number is verified at the time of a transaction.
